(19) United States
(12) Patent Application Publication
(10) Pub. No.: US 2006/0020478 A1
(43) Pub. Date: Jan. 26, 2006

(54) Genuine maker information memory reserved product input facilities & methodology

(76) Inventor: Eric Chang, Chunghe City (TW)

Correspondence Address: Leong C. Lei;PMB#1008, 1867 Ygnacio Valley Rd., Walnut Creek, CA, 94598, US

(21) Appl. No.: 10/894,040

(22) Filed: Jul. 20, 2004

(51) Int. Cl. G06Q 99/00

(52) U.S. Cl. 705/1

(57) ABSTRACT

A set of genuine maker information memory reserved product input facilities & methodology includes a product on the production line that is capable of reserving genuine maker information memories; an identification device being adapted to the product; a collector collecting the data stored in the identification device and then transmitting to a central server; the central server containing genuine maker information and verification facilities to produce corresponding genuine maker information and transmit the information into the input facilities, further into the product; the ID device contains data being assigned with a delivery series number linked by mathematic means to that in the genuine maker information stored in the central server; the central server transmitting the genuine maker information containing the delivery series number upon receiving the data from the ID device in the process flow to double check the procedure for the product to store the correct genuine maker information.

### BACKGROUND OF THE INVENTION

(a) Technical Field of the Invention

The present invention is related to a set of product input facilities and methodology requiring the reservation of the genuine maker information memory, and more particularly, to the input of the genuine maker information into a memory product by the employed manufacturer for the genuine maker or the consumer to locate product-related information in the memory of the product.

(b) Description of the Prior Art

Diversified electronic products due to advanced technology help make our work, living and entertainment more convenient and versatile. One of the main advantages about the electronic product is that it can deliver multiple functions to satisfy the needs of the majority. However, the end user has to rely on the operation manual and information on the specification of the electronic product to really enjoy its multiple functions. The rapid development of memory with higher capacity allows the genuine maker to register product related information into the memory for easy reference by the end user.

For a manufacturer of electronic products, inputting of information into the memory adapted to the product is not a problem. However, given the fact that modern technology advances by day, the life cycle of the product is shortened more rapidly. More attention has been paid to personalized use. Consequently, the range of products are increasing, and each type of product requires the input of dedicated data, and the task of inputting information into the memory adapted to the product is getting more complicated.

Furthermore, as the age of smaller profit margin is coming, many enterprises prefer the option of employing a professional manufacturer or a manufacturer with a lower production cost. It is not unusual for an employed manufacturer to deal with bookings of various types of products. In turn, the data to be inputted into the memory adapted to the product becomes more diversified than ever. Be it in-house production or employed manufacturing, the input of information into the memory adapted to the product has become a highly demanding precision task.

As illustrated in FIGS. 1 and 2 of the accompanying drawings, when it is necessary to input information into the product memory on the production line, the process of the prior art starts with the acceptance of a work order by a production controller (A). Using a floppy driver (C2) or a CD burner (C1), the production controller (A) first downloads into a corresponding medium diskette (C21) or a CD (C11) the genuine maker information stored in a hard disk (C3) in a computer (C). The production controller then delivers the medium diskette (C21) or the CD (C11) to the input staff (B1) on the product memory input line to input the information into multiple computers (D), (E), (F) etc.; in turn, the information is stored in the computer of the input staff (B1). Such operation of the production line on Day 1 for the first item of the product may not present any problem. However, when the information inputting operation involves many types of products and subsequent days of production, the problem may be emerged. For example, as illustrated in FIG. 3, the hard disk (D3) of the computer (D) has already contained genuine maker information of Items 1, 2, and 3 of Company A's products; and Items 1, 2, and 3 of Company B's products, and so on. For any act of omission by the input staff (B1) failing to make necessary deletion of the genuine maker information, it might be well possible that the genuine maker information of Item 1 of Company B's product is actually inputted instead of that of A's products are otherwise supposed to be inputted into the memory adapted to the product. Furthermore, as illustrated in FIG. 4, when the genuine maker information of Item 1 of Company B's product has been inputted into Item 1 of Company A's product by mistake, the mistake is discovered by the QC staff of stage 1, the products inputted with the wrong genuine maker information are immediately removed from the production line for rework. Even though the error has been discovered on the production line, the manufacturer suffers significant loss (such as the additional rework work hours, or delay in the production schedule and prevention other types from on line for production). If the error is detected only when delivered to the client or the client's dealer, more serious problems could eventuate. For example, when a confidential agreement has been entered between the employed manufacturer and Company A, the employed manufacturer could face serious consequences for betraying confidentiality since the employed manufacturer has inputted the genuine information of Company A into the memory of Company B's product and delivered the product to Company B.

Even there is the absence of betraying confidentiality and Company A waives its right to further inquire into this matter, the troubleshooting remains as a must. The employed manufacturer has to send its well-equipped service engineers to the client's (wherever it might be) to input the correct information into the product one by one. After the troubleshooting, the employed manufacturer still faces (1) punitive damages of delay in delivery, (2) the expenses of good name and possible loss of future bookings from the same client; and (3) the additional costs incurred from the troubleshooting. Therefore, the problem of making errors in inputting the genuine maker information to the product remains for employed manufacturers.

### SUMMARY OF THE INVENTION

The primary purpose of the present invention is to provide a set of genuine maker information memory reserved product input facilities and methodology to make sure that only the correct information is inputted.

To achieve the purpose, input facilities of the present invention are capable of directly displaying or by means of a monitor the genuine maker information of the product, how to input the genuine maker information, and how to take advantage of the input facilities to correctly input the genuine maker information into the memory adapted to the product. The input facilities include a production line adapted with a storage device that is capable of reserving the memories of the genuine maker information; a recognizable identification device provided to the storage device; a lower level data collection device in the form of a data collector of the recognizable identification device to recognize the recognizable identification device and retrieve the information; a middle level recognition and collection device in the form of a data collection server; a higher level data collection, checkup and transmission device in the form of a central server containing a device for the storage and checkup of the genuine maker information, and collecting data transmitted from the data servers to check up the same with the corresponding genuine maker information; and an input device to receive the data transmission from the data collection, checkup and transmission device on the upper level to the recognition collection device on the middle level, and further to the data collection device at the lower level; also input the data into the product allowing reservation of the genuine maker information to make it a product reserved with genuine maker information.

The methodology of the present invention to input the genuine maker information into the memory adapted to the product is characterized by having the recognizable identification device to contain a lot of data of the process flow card number; the genuine maker information is stored in the central server and contains a delivery series number; and the delivery series number is linked by mathematic method to each recognizable identification device. Once the central server receives the data of the recognized identification device in the process flow, it transmits the genuine maker information containing the delivery series number to be double checked for making sure that only the correct genuine maker information is inputted to the memory of the product.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a process flow chart of inputting information into memory adapted to a product on a production line of the prior art.

FIG. 2 is another process flow chart of inputting information into memory adapted to a product on a production line of the prior art.

FIG. 3 is a schematic view showing the error in the input of information into memory adapted to a production line of the prior art.

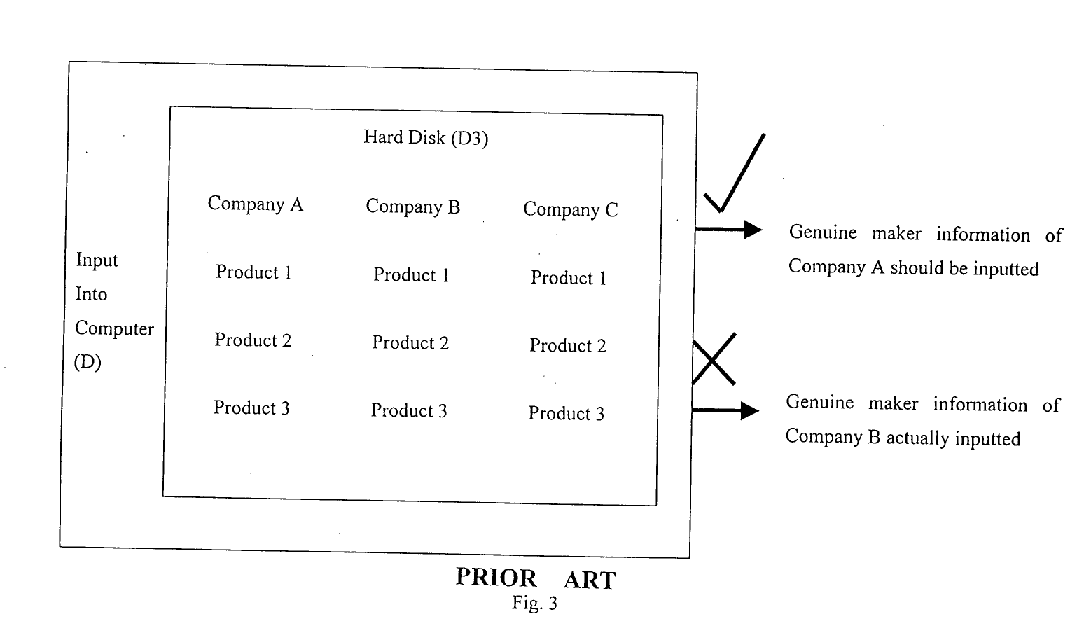

FIG. 4 is another schematic view showing the error in the input of information into memory adapted to a production line of the prior art.

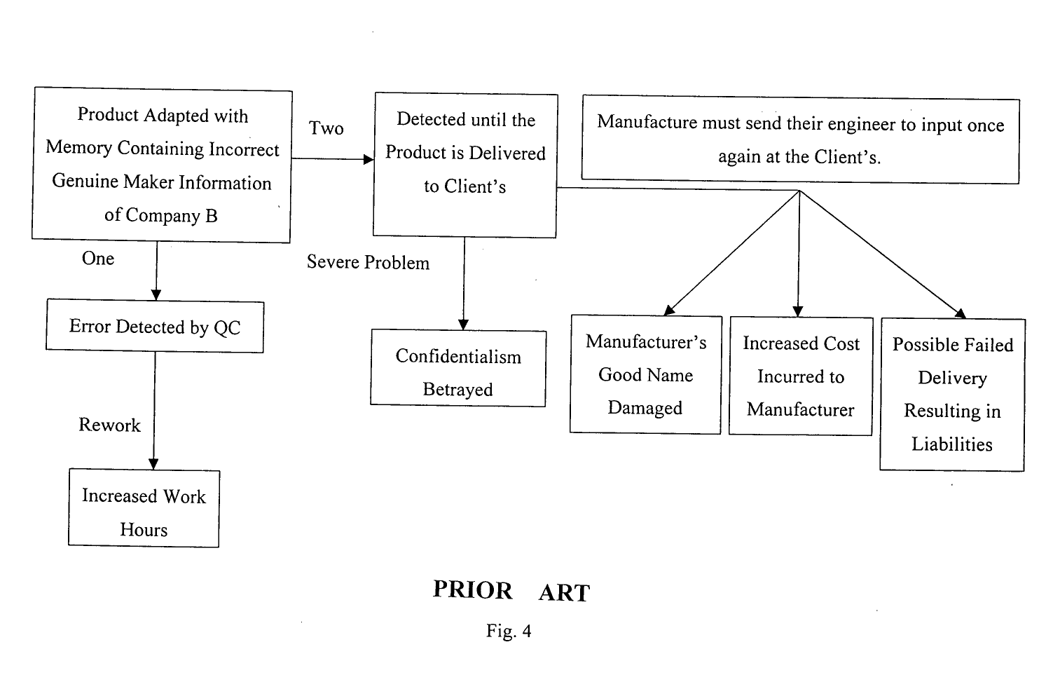

FIG. 5 is a schematic view showing the facilities of the present invention on the production line.

FIG. 6 is another schematic view showing the facilities of the present invention on the production line.

FIG. 6-1 is a process flow chart of a production line of the present invention.

FIG. 6-2 is another process flow chart of a production line of the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

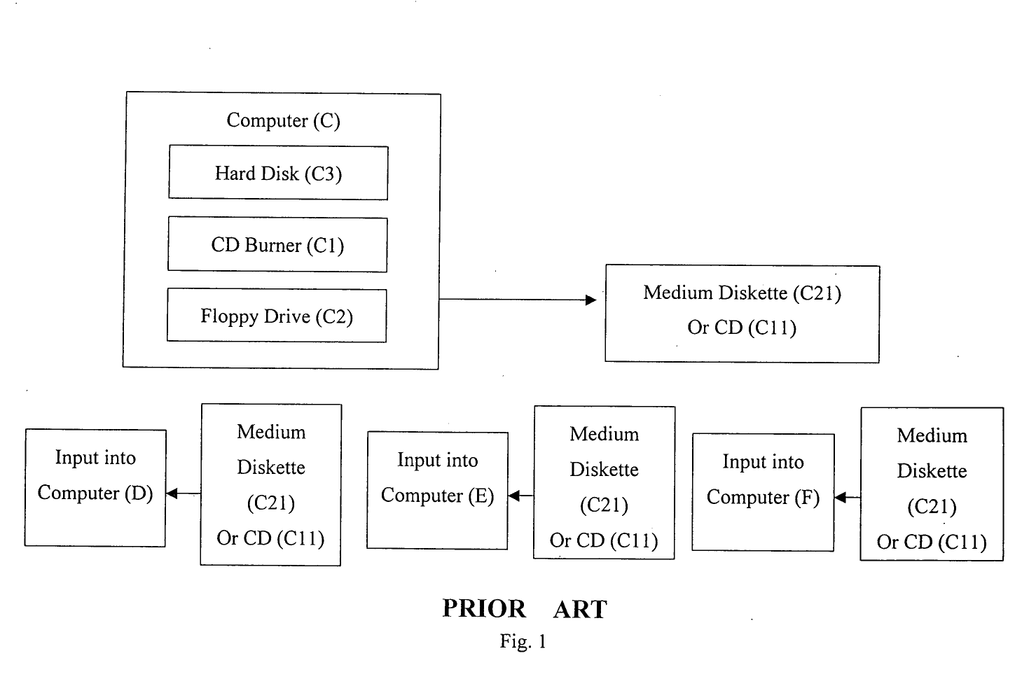

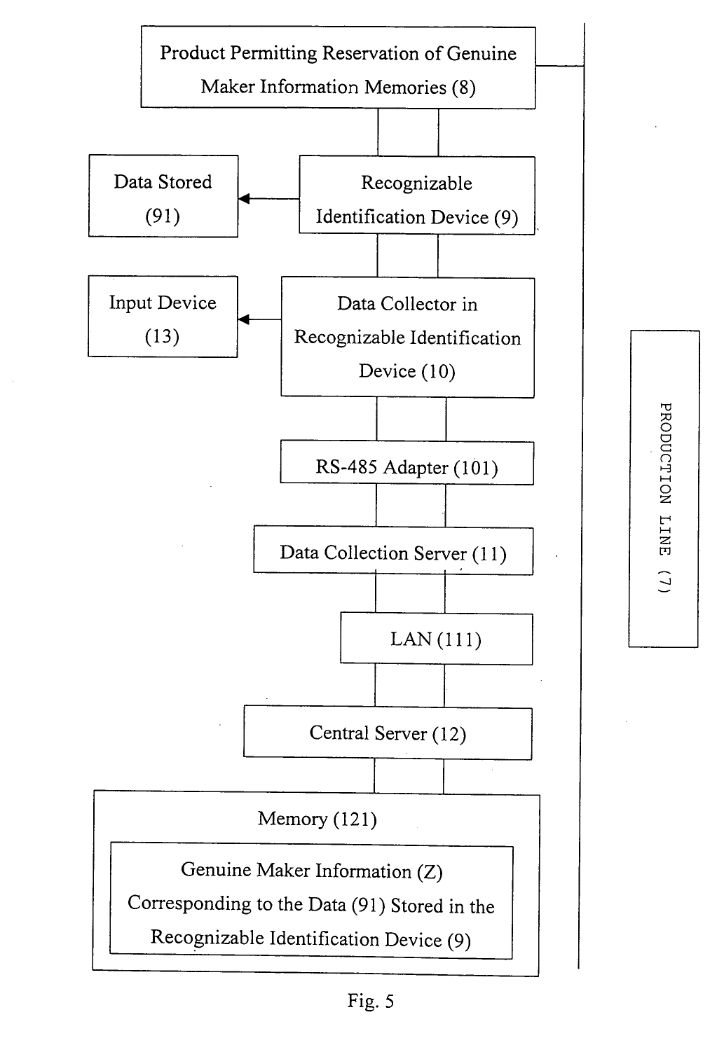

Referring to FIGS. 5, 6, and 6-1, the input facilities for the product to be reserved with the genuine maker information as illustrated in FIG. 5 is essentially comprised of a production line (7), a product to store the memories of the genuine maker information (8), a recognizable identification device (9), a data collector (10) to recognize the identification device, a data collection server (11), a central server (12), and an input device (13). The product (8) permitting the storage of the genuine maker information is disposed on the production line (7). The product (8) may be related to a monitor or DVD PLAY generally available in the market. The recognizable identification device (9) is placed on the product (8) so that it can be recognized. The recognizable identification device (9) may be in the form of a barcode or an induction chip and is capable of storing data (91). As the production line (7) moves, the product (8) permitting the storage of the genuine maker information with the recognizable identification device (9) is brought to the vicinity of the data collector (10), in a form of a barcode reader or induction chip receiver, of the recognizable identification device (9) for the data collector (10) to collect the data in the recognizable identification device (9) on the product (8) reserved with the genuine maker information, the data collector (10) to recognize the identification device immediately delivers the data collected to the data collector server (11), may be in a form of a PC, through an RS485 adapter (101). The data is then transmitted from the data collection server (11) through an LAN (111) to the central server (12).

The central server (12) contains a memory (121), and the memory (121) contains genuine maker information (Z) corresponding to that data (91) stored in the recognizable identification device (9). It is preferred that the central server (12) contains a PC with built-in Pentium PIII Xeon 700/1M*2 or above. When the central server (12) upon receiving the data (91) stored in the recognizable identification device (9) transmits the genuine maker information (Z) to the input device (13), which may be in the form of a PC, connected though the LAN (111), the data collection server (11), the data collector (1) to recognize the identification device, and an adapter is used to input the genuine maker information (Z) into the product (8) permitting the reservation of the genuine maker information. For example, a cable is used to connect a VGA Port otherwise an input device of a PC to the VGA Port of the product (8) permitting reservation of the genuine maker information otherwise a monitor to input the correct genuine maker information by means of the input device.

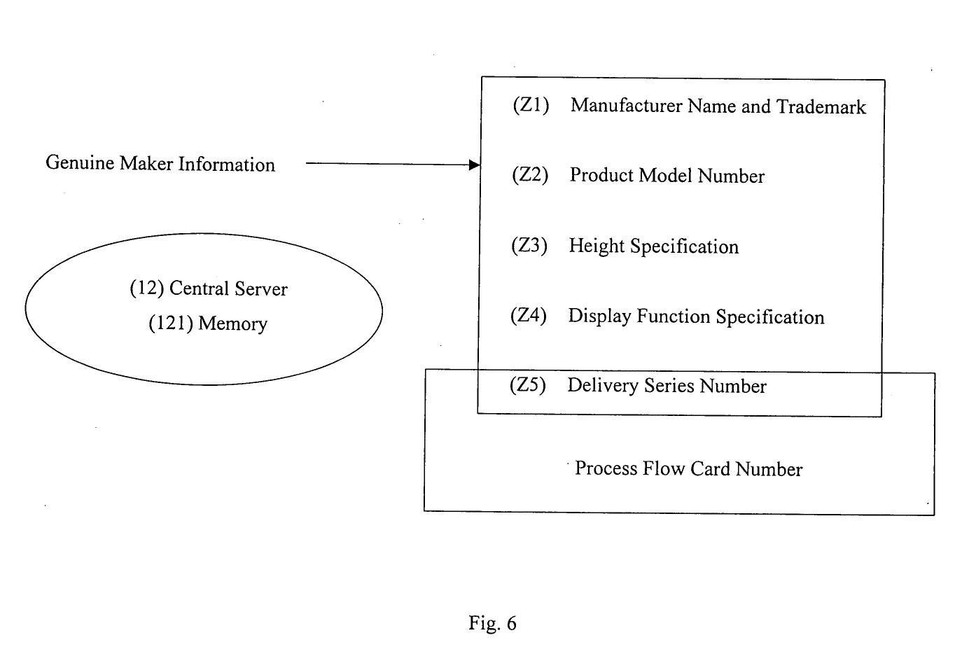

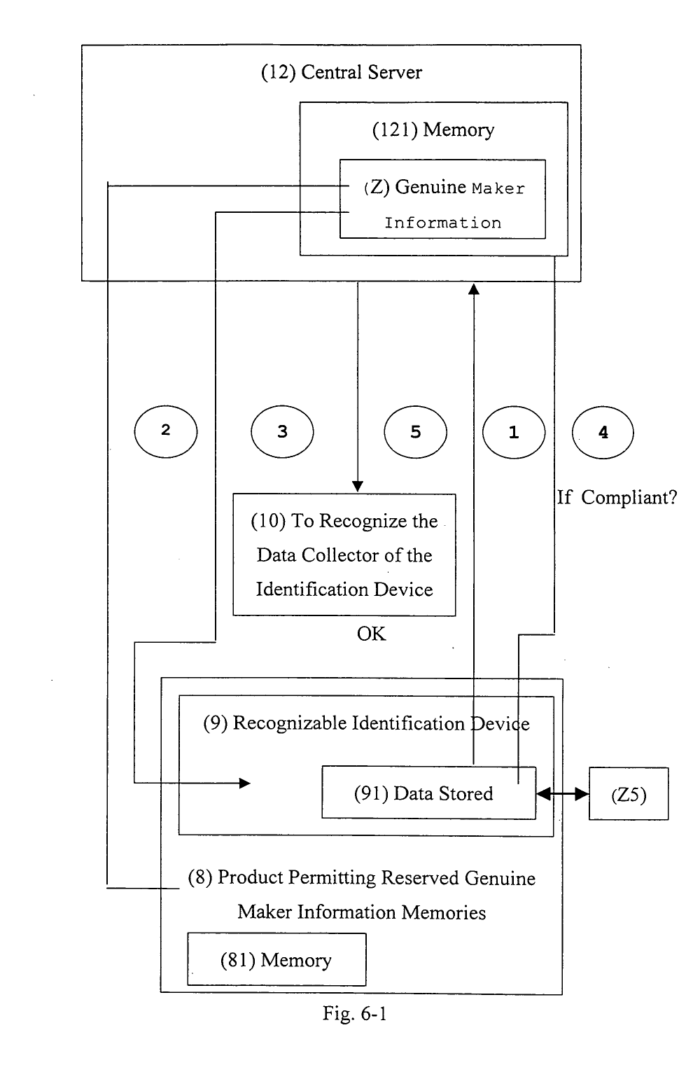

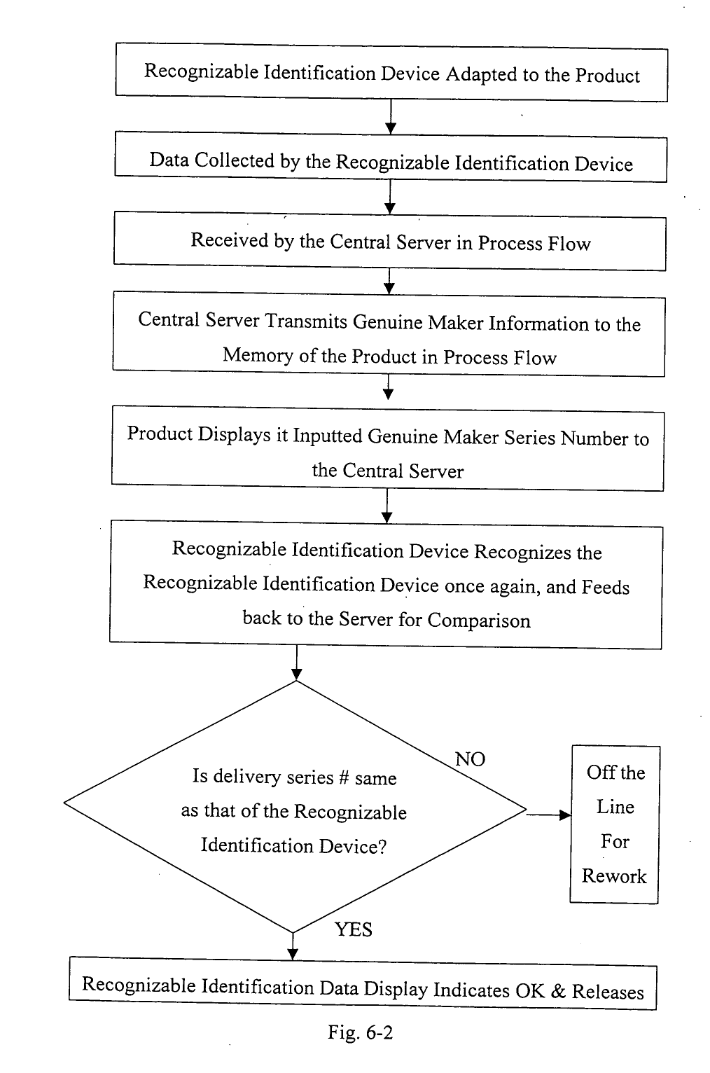

Additional to the input device described above, an alternative method is capable of more precisely executing the input based on the same set of input facilities of the present invention. As illustrated in FIG. 6, the process flow controller first creates a file of the genuine maker information (Z) assigned with a delivery series number and defines the relation between the number of the process flow card and the delivery series number. The product (8) containing a memory is placed on the production line as assigned with a recognizable identification device (9) containing the built-in data (91). In the process flow, the data collector (10) to recognize the identification device collects the data (91) from the recognizable identification device and transmits the data (91) to the data collection server (11), and further to the central server (12) where the data are checked with the data received by the device to recognize identification device before sending the correct genuine maker information (Z). The genuine maker information (Z) is then transmitted to the data collection server (11) and further to the output device (13) through the data collector (10) to recognize the identification device, and finally to the product (8) through the output device (13).

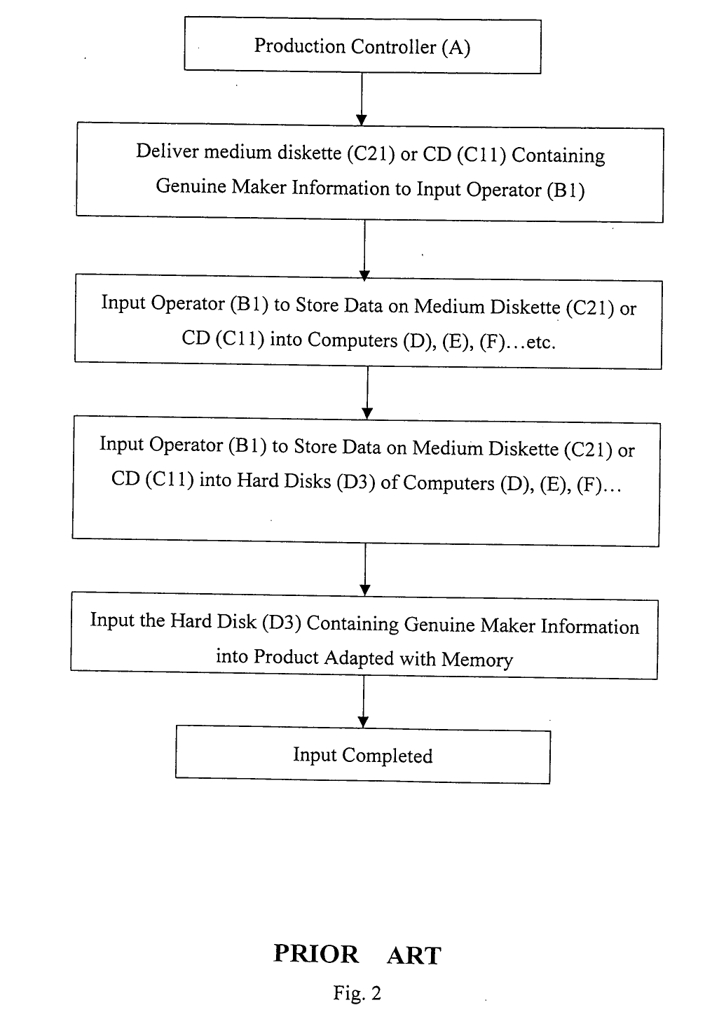

As illustrated in FIGS. 6-1 and 6-2, the methodology includes the following steps:
1. The recognizable identification device (9) contains a lot of data (91), i.e., the process flow card number to be transmitted to the central server (12);
2. The genuine maker information (Z) stored in the central server (12) is assigned with a delivery series number, and the process flow card number of the data (91) contained in each recognizable identification device (9) is linked to the delivery series number by mathematic means; accordingly, when the central server (12) receives the process flow card number from the data (91) of the recognized identification device (9);
3. The central server transmits the genuine maker information (Z) containing the delivery series number and inputs the information (Z) into the product (8);
4. After the double checking the data of the data collector (10) to recognize the identification device, and recognizing whether the process flow card number assigned to the data (91) stored in the recognizable identification device (9); and
5. The product (8) is inputted with the correct genuine maker information (Z).

Input facilities and methodology taught by the present invention provides the following advantages:

1. With the present invention, the production controller (A) saves significant time in the control of the production line since he no longer has to deliver the storage medium containing the corresponding genuine maker information (Z) to be input into the production line (7) to the input staff one production line after another as did in the past.

2. The input staff saves the time in the control of the output device (13) since it no longer is required to store any genuine maker information (Z).

3. Significant reduction of QC costs since QC staff is able to minimize, if not eliminate, the chance of inputting the wrong genuine maker information.

4. The damages otherwise payable due to betray of confidentiality or delayed delivery by inputting the wrong genuine maker information are minimized.

5. The elimination of the error in inputting the genuine maker information significantly promote the good name of the employed manufacturer due to the use of the present invention while the professional competence as an employed manufacturer is further improved in the piloting operation of entering the contract of employed manufacturing.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A set of genuine maker information memory reserved product input facilities include a production line, a product permitting reservation of memories of a genuine maker information being provided on the production line, a recognizable identification device as a lower level of data collection device being placed on the product permitting reservation of the genuine maker information; a data collection server as the middle level of data collection device to receive data from the recognizable identification device; a central server as the upper level data collection, checkup and transmission device containing devices for the storage and checkup of the genuine maker information, collecting the data transmitted by each data server and transmitting the corresponding genuine maker information after checkup; and an input device for executing the downward transmission of the data transmitted from the upper level of data checkup and transmission device to the middle level of collection device to recognize the data received, and further to the lower level of data collection device, and inputting the data to the product permitting the reservation of memories of the genuine maker information for the product to become one reserved with the memories of the genuine maker information.

2. The set of genuine maker information memory reserved product input facilities as claimed in claim 1, wherein, the product permitting the reservation of the genuine maker information is related to a monitor.

3. The set of genuine maker information memory reserved product input facilities as claimed in claim 2, wherein, the monitor is related to a liquid chip display.

4. The set of genuine maker information memory reserved product input facilities as claimed in claim 1, wherein, the recognizable identification device relates to a barcode.

5. The set of genuine maker information memory reserved product input facilities as claimed in claim 1, wherein, the data collector to recognize the identification device relates to a barcode reader.

6. The barcode reader as claimed in claim 5, wherein, it is related to a laser gun type barcode reader.

7. The set of genuine maker information memory reserved product input facilities as claimed in claim 1, wherein, the recognizable identification device relates to an induction chip.

8. The set of genuine maker information memory reserved product input facilities as claimed in claim 1, wherein, the data collector to recognize identification device relates to an induction chip receiver.

9. The barcode reader as claimed in claim 5, wherein, the data is connected to the data collection server by means of an RS485 adapter.

10. The set of genuine maker information memory reserved product input facilities as claimed in claim 1, wherein, the data collection server relates to a personal computer.

11. The data collection server as claimed in claim 1, wherein, the data are connected to the central server through a LAN.

12. The set of genuine maker information memory reserved product input facilities as claimed in claim 1, wherein, the central server functioning as the upper level data collection, checkup and transmission device containing a processor of Pentium PIII grade or above and built-in devices for the storage and checkup of the genuine maker information, collecting data transmitted by each data server, checking up and producing the corresponding genuine maker information.

13. The grade of the processor in the central server as claimed in claim 12, wherein, the grade is preferred to be of Pentium PIII Xeon 700/1M*2 or above.

14. Genuine maker information memory reserved product input facilities as claimed in claim 1, wherein, the input device relates to a personal computer for receiving the downward transmission of the data transmitted from the upper level collection, checkup and transmission device, through the middle level collection device to recognize to the collection device of the lower level in the process flow; and transmitting the data to the product permitting reservation of the memories of the genuine maker information for it to become a product reserved with the memories of the genuine maker information.

15. The personal computer claimed in claim 14, wherein, Pentium PIII or above is preferred for the central processor of the personal computer.

16. Genuine maker information memory reserved product input facilities as claimed in claim 1, wherein, the input device the input device receives the downward transmission of the data transmitted from the upper level collection, checkup and transmission device, through the middle level collection device to recognize to the collection device of the lower level in the process flow; and transmits the data to the product permitting reservation of the memories of the genuine maker information for it to become a product reserved with the memories of the genuine maker information; and the adapter of the input device relates to a D-SUB 15-pin.

17. A methodology of inputting genuine maker information into a product that requires to be reserved with the genuine maker information, wherein, a process flow controller first creates a file of the genuine maker information assigned with a delivery series number and defines the relation between the number of the process flow card and the delivery series number; the product containing a memory is placed on the production line as assigned with a recognizable identification device containing the built-in data; in the process flow, the data collector to recognize the identification device collects the data from the recognizable identification device and transmits the data to the data collection server, and further to the central server where the data are checked with the data received by the device to recognize identification device before sending the correct genuine maker information; the genuine maker information is then transmitted to the data collection server and further to the output device through the data collector to recognize the identification device, and finally to the product through the output device characterized by that the recognizable identification device contains a lot of data, i.e., the process flow card number to be transmitted to the central server; the genuine maker information stored in the central server is assigned with a delivery series number, and the process flow card number of the data contained in each recognizable identification device is linked to the delivery series number by mathematic means; accordingly, when the central server receives the process flow card number from the data of the recognized identification device; the central server transmits the genuine maker information containing the delivery series number and inputs the information into the product after the double checking the data and the product is inputted with the correct genuine maker information.

18. Genuine maker information memory reserved product input facilities as claimed in claim 17, wherein, the data is stored in the form of barcode in the recognizable identification device.

19. The barcode as claimed in claim 18, wherein, the barcode is executed in one-dimension barcode.

20. The barcode as claimed in claim 18, wherein, the barcode is executed in two-dimension barcode

21. The one-dimension barcode as claimed in claim 19, wherein, the one-dimension barcode is executed in the form of COD128.

22. A methodology of inputting genuine maker information into a product that requires to be reserved with the genuine maker information as claimed in claim 17, wherein, the genuine maker information includes name of the manufacturer, product model number, illumination specification, specification of display function and delivery series number.

23. A methodology of inputting genuine maker information into a product that requires to be reserved with the genuine maker information as claimed in claim 17, wherein, the mathematic means is executed by the logic complement method.

24. A methodology of inputting genuine maker information into a product that requires to be reserved with the genuine maker information as claimed in claim 17, wherein, the double checking procedure commences when the genuine maker information has been inputted into the product, the information is transmitted through the output device to the central server, the message of having completed the input to the product is availed, the device to recognize the identification device recognizes once again the recognizable identification device to confirm that the data in the identification device so recognized contains the correct delivery series number linked by mathematic means and that the genuine maker information stored in the central server matches that containing the delivery series number and having been inputted into the product for the product to be inputted with the correct genuine maker information.
